(19) United States
(12) Patent Application Publication
(10) Pub. No.: US 2026/0192339 A1
(43) Pub. Date: Jul. 9, 2026

(54) EFFICIENT LASER-BASED CLEANING FOR ROTATING MACHINE PARTS

(71) Applicant: International Business Machines Corporation, Armonk, NY (US)

(72) Inventors: Sarbajit Kumar Rakshit, Kolkata (IN); Sudheesh S. Kairali, Kozhikode (IN); Binoy Thomas, Kozhikode (IN)

(21) Appl. No.: 19/010,428

(22) Filed: Jan. 6, 2025

(51) Int. Cl. B08B 7/00; B08B 13/00; F03D 80/55

(52) U.S. Cl. CPC B08B 7/0042; B08B 13/00; B08B 2240/00; F03D 80/55

(57) ABSTRACT

A laser-based cleaning system is provided for cleaning a surface of a moving part. The laser-based cleaning system includes an emitter to emit a laser beam, a mounting to pivotably mount the emitter and a controller coupled to at least the emitter and the mounting. The controller is configured to control the emitter to emit a laser beam of sufficient power to clean the surface and to control the mounting to pivot the emitter in correspondence with movements of the surface to thereby direct the laser beam toward the surface while the surface moves.

### BACKGROUND

The present disclosure generally relates to rotating machine parts. More specifically, the present disclosure relates to a method and system for an efficient laser-based cleaning for rotating machine parts.

There are various types of rotating machines and machine parts that require periodic cleaning to maintain their efficiency and prevent issues such as dirt buildup, corrosion or mechanical failures. These machines and parts can be found in a wide range of equipment and machinery and include, but are not limited to, pulleys, conveyer belts, fan blades, turbines, centrifuges and wind turbine blades. In each example, parts can accumulate dirt, dust and debris that can negatively affect performance and lifespan.

### SUMMARY

According to an aspect of the disclosure, a laser-based cleaning system is provided for cleaning a surface of a moving part. The laser-based cleaning system includes an emitter to emit a laser beam, a mounting to pivotably mount the emitter and a controller coupled to at least the emitter and the mounting. The controller is configured to control the emitter to emit a laser beam of sufficient power to clean the surface and to control the mounting to pivot the emitter in correspondence with movements of the surface to thereby direct the laser beam toward the surface while the surface moves.

According to an aspect of the disclosure, a self-cleaning system is provided. The self-cleaning system includes a moving part having a surface and a laser-based cleaning system. The laser-based cleaning system includes an emitter to emit a laser beam, a mounting to pivotably mount the emitter and a controller coupled to at least the moving part, the emitter and the mounting. The controller is configured to control the emitter to emit a laser beam of sufficient power to clean the surface and to control the mounting to pivot the emitter in correspondence with movements of the surface to thereby direct the laser beam toward the surface while the surface moves.

According to an aspect of the disclosure, a method of laser-based cleaning of a surface of a moving part is provided. The method includes pivotably mounting an emitter configured to emit a laser beam on a mounting, determining a cleanliness condition, dimensions, a position, a direction of movement and a speed of movement of the surface and controlling the emitter and the mounting to execute laser-based cleaning of the surface in accordance with results of the determining. The controlling includes positioning the mounting to provide the emitter with a line-of-sight to the surface, controlling the emitter to emit the laser beam at a sufficient power to clean the surface and controlling the mounting to pivot the emitter during movement of the moving part such that the laser beam remains directed toward the surface.

Additional technical features and benefits are realized through the techniques of the present disclosure. Embodiments and aspects of the disclosure are described in detail herein and are considered a part of the claimed subject matter. For a better understanding, refer to the detailed description and to the drawings.

### BRIEF DESCRIPTION OF THE DRAWINGS

The specifics of the exclusive rights described herein are particularly pointed out and distinctly claimed in the claims at the conclusion of the specification. The foregoing and other features and advantages of the embodiments of the disclosure are apparent from the following detailed description taken in conjunction with the accompanying drawings in which:

FIG. 1 is a schematic diagram of a computing environment executing laser-based cleaning in accordance with one or more embodiments of the present invention;

FIG. 2 is a schematic illustration of a rotating part in accordance with one or more embodiments;

FIG. 3 is a schematic illustration of a linearly moving part in accordance with one or more embodiments;

FIGS. 4A and 4B illustrate a self-cleaning system including a laser-based cleaning system in accordance with one or more embodiments;

FIG. 5 is a schematic diagram of a controller of the self-cleaning system of FIGS. 4A and 4B; and

FIG. 6 is a flow diagram illustrating a method of laser-based cleaning in accordance with one or more embodiments.

The diagrams depicted herein are illustrative. There can be many variations to the diagram or the operations described therein without departing from the spirit of the disclosure. For instance, the actions can be performed in a differing order or actions can be added, deleted or modified. Also, the term “coupled” and variations thereof describes having a communications path between two elements and does not imply a direct connection between the elements with no intervening elements/connections between them. All of these variations are considered a part of the specification.

In the accompanying figures and following detailed description of the described embodiments, the various elements illustrated in the figures are provided with two or three digit reference numbers. With minor exceptions, the leftmost digit(s) of each reference number correspond to the figure in which its element is first illustrated.

### DETAILED DESCRIPTION

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment ("CPP embodiment" or “CPP”) is a term used in the present disclosure to describe any set of one, or more, storage media (also called "mediums") collectively included in a set of one, or more, storage devices that collectively include machine readable code corresponding to instructions and/or data for performing computer operations specified in a given CPP claim. A "storage device" is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits / lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

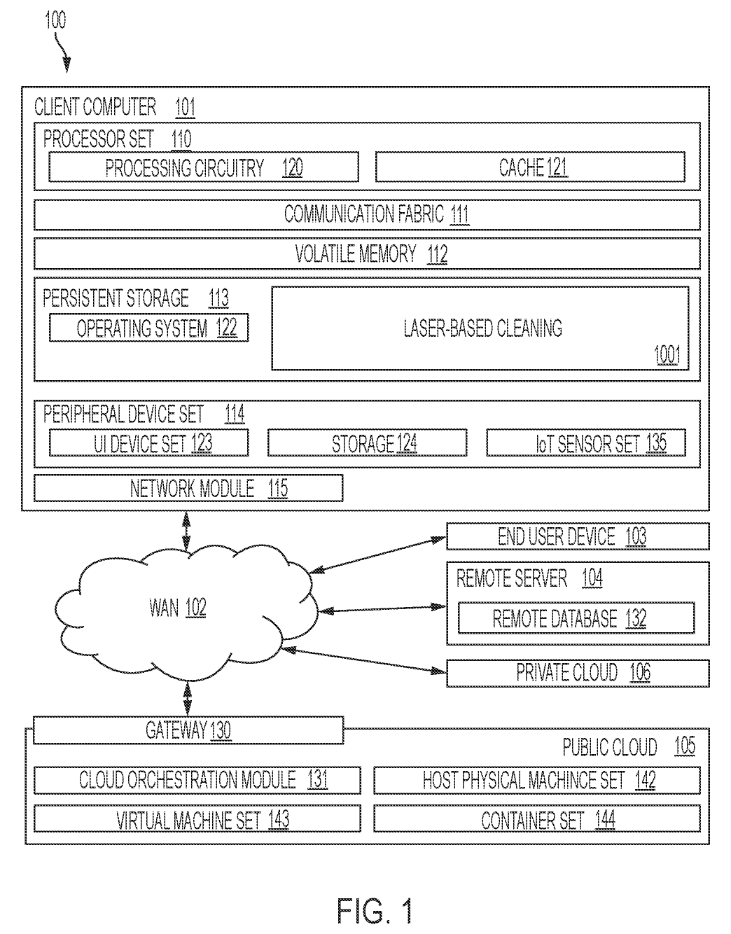

With reference to FIG. 1, a computer or computing device 100 that implements a computer-implemented method for laser-based cleaning is provided in accordance with one or more embodiments of the present invention is provided. The computer or computing device 100 of FIG. 1 contains an example of an environment for the execution of at least some of the computer code involved in performing the inventive methods, such as the block 1001 of the computer-implemented method for laser-based cleaning and application. In addition to the computer-implemented method for laser-based cleaning of block 1001, the computer or computing device 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and the computer-implemented method of block 1001, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

The computer 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of the computer-implemented method, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

The processor set 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In the computer-implemented method, at least some of the instructions for performing the inventive methods may be stored in the block 1001 of the computer-implemented method in persistent storage 113.

Communication fabric 111 is the signal conduction path that allows the various components of computer 101 to communicate with each other. Typically, this fabric is made of switches and electrically conductive paths, such as the switches and electrically conductive paths that make up busses, bridges, physical input / output ports and the like. Other types of signal communication paths may be used, such as fiber optic communication paths and/or wireless communication paths.

Volatile memory 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

Persistent storage 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The code included in the block 1001 of the computer-implemented method typically includes at least some of the computer code involved in performing the inventive methods.

Peripheral device set 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

Network module 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

End user device (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

Remote server 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

Public cloud 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

Private cloud 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud

For the sake of brevity, conventional fabrication techniques may or may not be described in detail herein. Moreover, the various tasks and process steps described herein can be incorporated into a more comprehensive procedure or process having additional steps or functionality not described in detail herein. In particular, various steps in the manufacture of certain types of devices are well known and so, in the interest of brevity, many conventional steps will only be mentioned briefly herein or will be omitted entirely without providing the well-known process details.

Turning now to an overview of technologies that are more specifically relevant to aspects of the disclosure, laser-cleaning is the process of using a high-energy laser beam to remove contaminants such as rust, paint, grease and/or other unwanted substances from a surface. A laser beam is directed at the material to be cleaned, where it instantly vaporizes or ablates the contaminant, leaving behind a pristine surface. Laser-cleaning is notable for precision and versatility and can be adjusted to remove specific materials while leaving an underlying substrate untouched. This precision is invaluable when dealing with delicate or intricate parts, such as historic artifacts or intricate machinery components. Laser-cleaning is also environmentally friendly, non-destructive, cost-efficient, safe and able to contribute to high-productivity.

Laser-cleaning can be used in various applications. In manufacturing, laser-cleaning is used for rust and paint removal from metal surfaces, as well as cleaning molds and tooling in various manufacturing processes. In the aerospace industry, laser-cleaning can remove coatings and contaminants from critical aircraft components. In the automotive industry, laser-cleaning is employed for paint stripping and surface preparation. Art restorers use laser-cleaning to remove dirt, soot and other contaminants from historical artifacts and works of art. Wind turbine blades, solar panels and other renewable energy equipment an also benefit from laser-cleaning to maintain efficiency.

A laser-cleaning process involves several key components. These include, but are not limited to, a high-power laser source that emits a concentrated beam of light, optical elements to focus the laser beam to a precise spot and contaminant removal and collection systems.

In certain industrial settings, the cleaning of rotating machine parts is a time-consuming and costly process that often requires the machines to be stopped for maintenance. This downtime results in reduced productivity and increased expenses. Additionally, the lack of real-time data on the condition of the machine parts and the type of accumulated dirt makes the cleaning process inefficient and sometimes ineffective. Therefore, a method and system are needed for cleaning rotating machine parts or rotating machines without stopping.

Turning now to an overview of the aspects of the disclosure, one or more embodiments of the disclosure address the above-described shortcomings of the prior art by providing a laser-based cleaning system that synchronizes a direction and strength of a laser beam with a linear speed of various segments of a rotating machine or rotating machine parts. The laser-based cleaning system will consider length of time and specifications of accumulated dirt on the surfaces to be cleaned. This ensures that effective cleaning can be carried out without the need to stop operations. As a result, the rotating machines can remain productive while the cleaning process is performed.

The laser-based cleaning system can communicate with rotating machines to establish optimal positioning and direction of the laser beam to ensure that the laser beam maintains the necessary strength and the required angular direction for cleaning and to ensure that there are no obstacles in the path of the laser beam especially when parts change speed and/or direction. A laser beam emission module could be mounted on a computer-controlled pivot system to allows for synchronization with various segments of the rotating machine and machine parts. Visual and internet of things (IoT) feed analysis could allow for leveraging of artificial intelligence (AI) systems to identify specifications and types of dirt that have accumulated on various segments of rotating machine parts. The laser beam can then be provided with a corresponding strength.

Turning now to an overview of the aspects of the disclosure, one or more embodiments of the disclosure address the above-described shortcomings of the prior art by providing a laser-based cleaning system for cleaning a surface of a moving part. The laser-based cleaning system includes an emitter to emit a laser beam, a mounting to pivotably mount the emitter and a controller coupled to at least the emitter and the mounting. The controller is configured to control the emitter to emit a laser beam of sufficient power to clean the surface and to control the mounting to pivot the emitter in correspondence with movements of the surface to thereby direct the laser beam toward the surface while the surface moves.

The emitter of the laser-based cleaning system could be mounted on a programmatic controlled pivotal joint so that a direction of the laser beam can be controlled. The laser beam strength can also be altered based on the need. The mounting can be mobile on various types of surfaces and can include various types of motors and actuators for moving, pivoting, orienting and re-orienting the emitter in real-time. The emitter and/or the mounting can include various types of sensors to capture real-time data on the condition of a surface being cleaned with the sensors providing information on dirt accumulation, machine speed and obstacles, an AI system that processes data from sensors and/or camera feeds as well as historical data to identify a type and specifications of dirt on machine parts and to calculate requirements for and to adjust laser beam strength for cleaning.

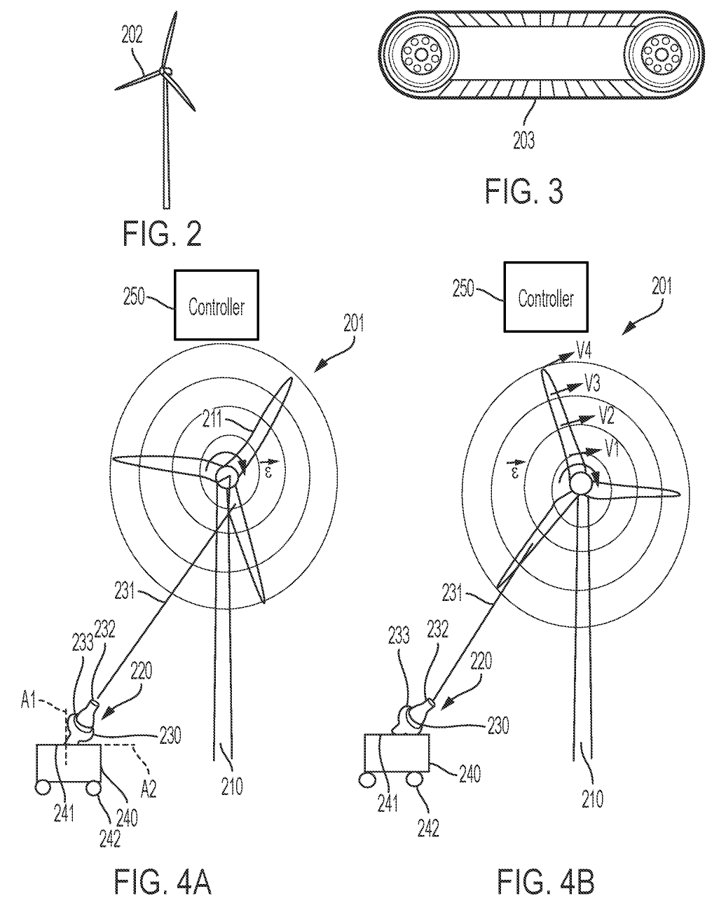

With reference to FIGS. 2 and 3 and FIGS. 4A and 4B, a self-cleaning system 201 is provided and includes a moving part 210 having a surface 211. The moving part 210 can be any type of moving part, such as a rotating part 202 as shown in the illustration of a wind turbine blade of FIG. 2 and a belt 203 as shown in the illustration of the conveyer belt of FIG. 3. The following description will generally relate to the cases in which the moving part 210 is a rotating part, such the rotating part 202 of FIG. 2. This is being done for purposes of clarity and brevity and should not be interpreted as limiting the scope of the disclosure or the claims in any way.

As shown in FIGS. 4A and 4B, the self-cleaning system 201 includes the moving part 210 having the surface 211 and further includes a laser-based cleaning system 220. The laser-based cleaning system 220 includes an emitter 230 configured to emit a laser beam 231, a mounting 240 configured to pivotably mount the emitter 230 and a controller 250 coupled to at least the emitter 230 and the mounting 240 and, in some cases, the moving part 210. The controller 250 is configured to control the emitter 230 to emit the laser beam 231 at a sufficient power to clean the surface 211 and to control the mounting 240 to pivot the emitter 230 in correspondence with movements of the surface 211 to thereby direct the laser beam 231 toward the surface 211 while the surface 211 moves. In this way, the self-cleaning system 201 provides for a laser-based cleaning of the surface 211 while the moving part 210 (i.e., the wind turbine) continues operating and thus does not require the moving part 210 to stop operating (i.e., for the wind turbine to stop generating electricity).

The emitter 230 can include an emitter portion 232 to emit the laser beam 231 and, in some cases, a sensor portion 233. The sensor portion 233 can be configured to sense a cleanliness state of the surface 211. In these or other cases, the sensor portion 233 and/or the emitter 230 as a whole can be further configured to generate data reflective of the cleanliness state of the surface 211 and to forward the data to the controller 250. The controller 250 can be further configured to control the emitter 230 and the mounting 240 in accordance with at least the data.

The mounting 240 can include a mounting portion 241 and a movement portion 242. The mounting portion 241 can be configured to pivotably mount the emitter 230 in such a way as to allow the emitter 230 to be rotated about a central axis A1 (see FIG. 4A) and to pivot upwardly and downwardly relative to a horizontal axis A2 (see FIG. 4A). The movement portion 242 can be provided as wheels and/or a track or other suitable elements that allow the mounting 240 to be movable relative to the moving part 210. The controller 250 can be further configured to control movements of the mounting 240 in order to position the emitter 230 with a line-of-sight to the surface 211 over at least a portion or all of the path traced by the surface 211 during movements thereof.

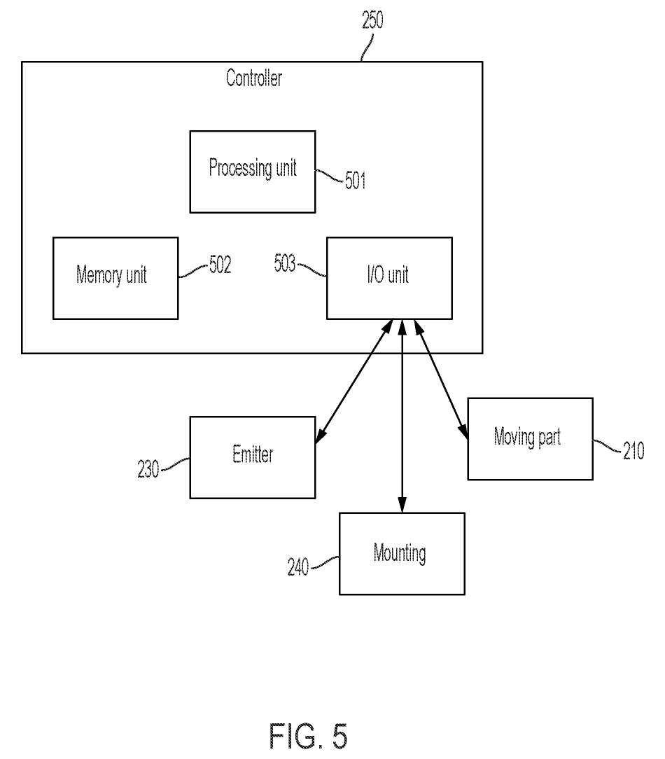

With reference to FIG. 5, the controller 250 can include a processing unit 501, a memory unit 502 and an input/output (I/O) unit 503 by which the processing unit 501 is communicative with the emitter 230 and the mounting 240. The memory unit 502 has executable instructions stored thereon. The executable instructions are readable and executable by the processing unit 501. When the executable instructions are read and executed by the processing unit 501, the controller 250 as a whole is caused to operate as described herein. As an example, the controller 250 can be coupled to the emitter 230 and the mounting 240 as noted above and can be additionally coupled to the moving part 210. In these or other cases, the controller 250 can be receptive of information relating to the moving part 210 and can be configured to control the emitter 230 and the mounting 240 in accordance with at least the information. The information can include at least one or more of a cleanliness condition of the surface 211, dimensions of the surface 211, a position of the surface 211 at any given time, a direction of movement of the surface 211 and a speed of movement of the surface 211. The processing unit 501 can then analyze the information, can issue signals to the mounting 240 via the I/O unit 503 to position the mounting 240 so as to provide the emitter 230 with a line-of-sight to the surface 211 over at least a portion or all of the path traced by the surface 211 during movements thereof and can issue signals to the emitter 230 via the I/O unit 503 to control the emitter 230 to emit the laser beam 231 toward the surface 211 while the surface 211 moves at a sufficient power to laser-clean the surface 211. The processing unit 501 can also employ data generated by the sensor portion 233 to determine when the surface 211 or a portion thereof is cleaned as a way of determining when to begin cleaning another portion of the surface 211.

In addition, in accordance with one or more embodiments, the processing unit 501 of the controller 250 can be configured to generate an artificial intelligence (AI) model to model a cleanliness condition of the surface 211 and can issues signals to the emitter 230 and the mounting 240 via the I/O unit 503 to thereby control the emitter 230 and the mounting 240 in accordance with at least the model (along with the data generated by the sensor portion 233, the information received from the moving part 210, etc.).

The model can be provided as a dust accumulation model that combines physical measurements and computational simulations and which aims to simulate the accumulation of dust on various parts of the moving part 210. The processing unit 501 will receive the objectives and results of the dust accumulation model, such as identifications of how dust affects machine performance, maintenance scheduling, or optimizing cleaning processes, and the level of cleaning. The dust accumulation model will obtain data and historical data related to the moving part 210, including its design, operating conditions, and dust properties (e.g., particle size, density, and shape), will create a 3D model of the moving part 210 and will make use of computational fluid dynamics (CFD) to simulate flows of air and dust particles to thereby predict fluid flow and dust dispersion with specified boundary conditions, such as airflow rates, temperatures and dust particle properties, etc. The dust accumulation model can also incorporate models for dust deposition onto different types of surfaces for different types of moving parts 210.

Where the moving part 210 is one of multiple moving parts 210, such as where the moving part 210 is a blade of a wind turbine with three total blades, each moving part 210 has a surface 211 to be cleaned. In these or other cases, the controller 250 can controls the emitter 230 and the mounting 240 in multiple manners. In a first exemplary manner, the controller 250 can control the emitter 230 and the mounting 240 to clean same portions of each surface 211 of the multiple moving parts 210 before cleaning next portions of each surface 211 of the multiple moving parts 210. That is, the controller 250 can control the emitter 230 and the mounting 240 to first clean inboard portions of each surface 211 of each moving part 210 and then to sequentially clean increasingly outboard portions of each surface 211 of each moving part 210. In a second exemplary manner, the controller 250 can control the emitter 230 and the mounting 240 to clean each portion of each surface 211 of each of the multiple moving parts 210 before cleaning a portion of a surface 211 of a next one of the multiple moving parts 210. That is, as shown in FIGS. 4A and 4B, the controller 250 can control the emitter 230 and the mounting 240 to clean an entire surface 211 of one of the moving parts 210 before moving on to clean an entire surface 211 of another one of the moving parts.

In each case, the controller 250 will have information relating to the dimensions of the surface 211 and thus will recognize that the surface 211 has inboard portions, increasingly outboard portion and ultimately outboard portions and that increasingly outboard portions will have correspondingly increasingly angular velocity (see, e.g., velocities V1, V2, V3 and V4 of FIG. 4B). As such, the controller 250 will control the mounting 240 in particular to pivot the emitter 230 increasingly quickly as the portion of the surface 211 that is being cleaned progresses increasingly outboard.

In certain cases, the controller 250 will calculate a rotational speed of the moving part 210 and will identify a locus of each point on the surface 211 from a reference point. While the moving part 210 is operational, the controller 250 will calculate the rotational speed of the surface 211 and identify the path of each point thereon (i.e., using information and/or sensors). Based on the rotational speed, an angular displacement of the surface 211 can be calculated by finding the difference in angular positions at different time intervals.

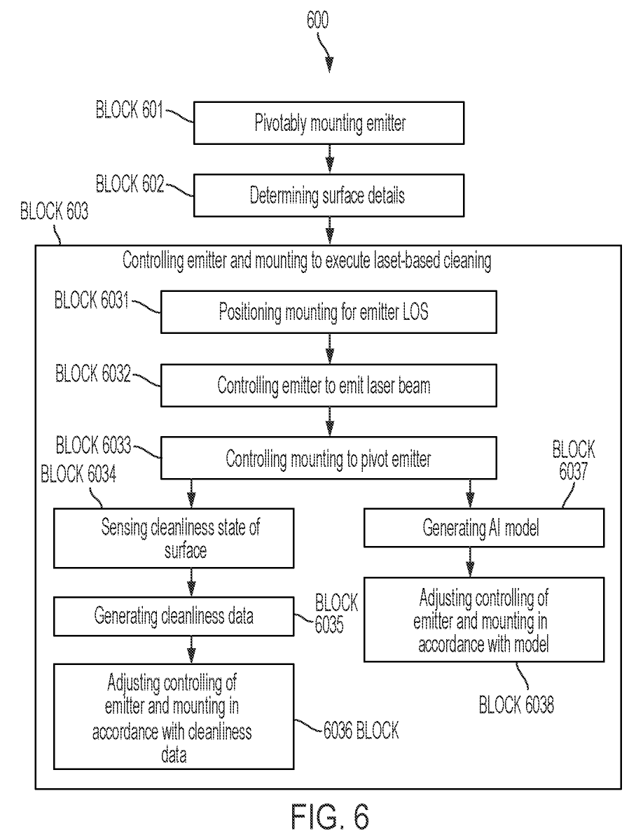

With reference to FIG. 6, a method 600 of laser-based cleaning of a surface of a moving part, such as the surface 211 of the moving part 210 described above, is provided. The method 600 includes pivotably mounting an emitter configured to emit a laser beam on a mounting (block 601), determining at least one or more of a cleanliness condition, dimensions, a position, a direction of movement and a speed of movement of the surface (block 602) and controlling the emitter and the mounting to execute laser-based cleaning of the surface in accordance with results of the determining (block 603). The controlling of block 603 includes positioning the mounting to provide the emitter with a line-of-sight to the surface (block 6031), controlling the emitter to emit the laser beam at a sufficient power to clean the surface (block 6032) and controlling the mounting to pivot the emitter during movement of the moving part such that the laser beam remains directed toward the surface (block 6033).

In some cases, the controlling of block 603 can further include sensing a cleanliness state of the surface (block 6034), generating data reflective of the cleanliness state (block 6035) and adjusting the controlling of the emitter and the mounting in accordance with at least the data (block 6036). In some cases, the controlling of block 603 can further include generating an artificial intelligence (AI) model to model a cleanliness condition of the surface (block 6037) and adjusting the controlling of the emitter and the mounting in accordance with at least the model (block 6038).

Various embodiments of the present disclosure are described herein with reference to the related drawings. Alternative embodiments can be devised without departing from the scope of this disclosure. Although various connections and positional relationships (e.g., over, below, adjacent, etc.) are set forth between elements in the following description and in the drawings, persons skilled in the art will recognize that many of the positional relationships described herein are orientation-independent when the described functionality is maintained even though the orientation is changed. These connections and/or positional relationships, unless specified otherwise, can be direct or indirect, and the present disclosure is not intended to be limiting in this respect. Accordingly, a coupling of entities can refer to either a direct or an indirect coupling, and a positional relationship between entities can be a direct or indirect positional relationship. As an example of an indirect positional relationship, references in the present description to forming layer “A” over layer “B” include situations in which one or more intermediate layers (e.g., layer “C”) is between layer “A” and layer “B” as long as the relevant characteristics and functionalities of layer “A” and layer “B” are not substantially changed by the intermediate layer(s).

The following definitions and abbreviations are to be used for the interpretation of the claims and the specification. As used herein, the terms “comprises,” “comprising,” “includes,” “including,” “has,” “having,” “contains” or “containing,” or any other variation thereof, are intended to cover a non-exclusive inclusion. For example, a composition, a mixture, process, method, article, or apparatus that comprises a list of elements is not necessarily limited to only those elements but can include other elements not expressly listed or inherent to such composition, mixture, process, method, article, or apparatus.

Additionally, the term “exemplary” is used herein to mean “serving as an example, instance or illustration.” Any embodiment or design described herein as “exemplary” is not necessarily to be construed as preferred or advantageous over other embodiments or designs. The terms “at least one” and “one or more” are understood to include any integer number greater than or equal to one, i.e. one, two, three, four, etc. The terms “a plurality” are understood to include any integer number greater than or equal to two, i.e. two, three, four, five, etc. The term “connection” can include an indirect “connection” and a direct “connection.”

References in the specification to “one embodiment,” “an embodiment,” “an example embodiment,” etc., indicate that the embodiment described can include a particular feature, structure, or characteristic, but every embodiment may or may not include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

For purposes of the description hereinafter, the terms “upper,” “lower,” “right,” “left,” “vertical,” “horizontal,” “top,” “bottom,” and derivatives thereof shall relate to the described structures and methods, as oriented in the drawing figures. The terms “overlying,” “atop,” “on top,” “positioned on” or “positioned atop” mean that a first element, such as a first structure, is present on a second element, such as a second structure, wherein intervening elements such as an interface structure can be present between the first element and the second element. The term “direct contact” means that a first element, such as a first structure, and a second element, such as a second structure, are connected without any intermediary conducting, insulating or semiconductor layers at the interface of the two elements.

Spatially relative terms, e.g., “beneath,” “below,” “lower,” “above,” “upper,” and the like, can be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the term “below” can encompass both an orientation of above and below. The device can be otherwise oriented (rotated 90 degrees or at other orientations) and the spatially relative descriptors used herein interpreted accordingly.

The phrase “selective to,” such as, for example, “a first element selective to a second element,” means that the first element can be etched and the second element can act as an etch stop.

The terms “about,” “substantially,” “approximately,” and variations thereof, are intended to include the degree of error associated with measurement of the particular quantity based upon the equipment available at the time of filing the application. For example, “about” can include a range of ± 8% or 5%, or 2% of a given value.

For the sake of brevity, conventional techniques related to semiconductor device and integrated circuit (IC) fabrication may or may not be described in detail herein. By way of background, however, a more general description of the semiconductor device fabrication processes that can be utilized in implementing one or more embodiments of the present disclosure will now be provided. Although specific fabrication operations used in implementing one or more embodiments of the present disclosure can be individually known, the described combination of operations and/or resulting structures of the present disclosure are unique. Thus, the unique combination of the operations described in connection with the fabrication of a semiconductor device according to the present disclosure utilize a variety of individually known physical and chemical processes performed on a semiconductor (e.g., silicon) substrate, some of which are described in the immediately following paragraphs.

In general, the various processes used to form a micro-chip that will be packaged into an IC fall into four general categories, namely, film deposition, removal/etching, semiconductor doping and patterning/lithography. Deposition is any process that grows, coats, or otherwise transfers a material onto the wafer. Available technologies include physical vapor deposition (PVD), chemical vapor deposition (CVD), electrochemical deposition (ECD), molecular beam epitaxy (MBE) and more recently, atomic layer deposition (ALD) among others. Removal/etching is any process that removes material from the wafer. Examples include etch processes (either wet or dry), and chemical-mechanical planarization (CMP), and the like. Semiconductor doping is the modification of electrical properties by doping, for example, transistor sources and drains, generally by diffusion and/or by ion implantation. These doping processes are followed by furnace annealing or by rapid thermal annealing (RTA). Annealing serves to activate the implanted dopants. Films of both conductors (e.g., poly-silicon, aluminum, copper, etc.) and insulators (e.g., various forms of silicon dioxide, silicon nitride, etc.) are used to connect and isolate transistors and their components. Selective doping of various regions of the semiconductor substrate allows the conductivity of the substrate to be changed with the application of voltage. By creating structures of these various components, millions of transistors can be built and wired together to form the complex circuitry of a modern microelectronic device. Semiconductor lithography is the formation of three-dimensional relief images or patterns on the semiconductor substrate for subsequent transfer of the pattern to the substrate. In semiconductor lithography, the patterns are formed by a light sensitive polymer called a photo-resist. To build the complex structures that make up a transistor and the many wires that connect the millions of transistors of a circuit, lithography and etch pattern transfer steps are repeated multiple times. Each pattern being printed on the wafer is aligned to the previously formed patterns and slowly the conductors, insulators and selectively doped regions are built up to form the final device.

The flowchart and block diagrams in the Figures illustrate possible implementations of fabrication and/or operation methods according to various embodiments of the present disclosure. Various functions/operations of the method are represented in the flow diagram by blocks. In some alternative implementations, the functions noted in the blocks can occur out of the order noted in the Figures. For example, two blocks shown in succession can, in fact, be executed substantially concurrently, or the blocks can sometimes be executed in the reverse order, depending upon the functionality involved.

The descriptions of the various embodiments of the present disclosure have been presented for purposes of illustration, but are not intended to be exhaustive or limited to the embodiments described. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments described herein.

What is claimed is:

1. A laser-based cleaning system for cleaning a surface of a moving part, the laser-based cleaning system comprising:
an emitter to emit a laser beam;
a mounting to pivotably mount the emitter; and
a controller coupled to at least the emitter and the mounting,
the controller being configured to control the emitter to emit a laser beam of sufficient power to clean the surface and to control the mounting to pivot the emitter in correspondence with movements of the surface to thereby direct the laser beam toward the surface while the surface moves.

2. The laser-based cleaning system according to claim 1, wherein the moving part is at least one of a rotating part and a linearly moving part.

3. The laser-based cleaning system according to claim 1, wherein the emitter comprises:
an emitter portion to emit the laser beam; and
a sensor portion to sense a cleanliness state of the surface, to generate data reflective of the cleanliness state and to forward the data to the controller,
wherein the controller is further configured to control the emitter and the mounting in accordance with at least the data.

4. The laser-based cleaning system according to claim 1, wherein the mounting is movable relative to the moving part and the controller is further configured to control movements of the mounting.

5. The laser-based cleaning system according to claim 1, wherein:
the controller is receptive of information relating to the moving part and controls the emitter and the mounting in accordance with at least the information, and
the information comprises at least one or more of a cleanliness condition of the surface, dimensions of the surface, a position of the surface, a direction of movement of the surface and a speed of movement of the surface.

6. The laser-based cleaning system according to claim 1, wherein the controller generates an artificial intelligence (AI) model to model a cleanliness condition of the surface and controls the emitter and the mounting in accordance with at least the model.

7. The laser-based cleaning system according to claim 1, wherein:
the moving part is one of multiple moving parts, each having a surface to be cleaned, and
the controller controls the emitter and the mounting to clean same portions of each surface of the multiple moving parts before cleaning next portions of each surface of the multiple moving parts.

8. The laser-based cleaning system according to claim 1, wherein:
the moving part is one of multiple moving parts, each having a surface to be cleaned, and
the controller controls the emitter and the mounting to clean each portion of each surface of each of the multiple moving parts before cleaning a portion of a surface of a next one of the multiple moving parts.

9. A self-cleaning system, comprising:
a moving part having a surface; and
a laser-based cleaning system comprising:
an emitter to emit a laser beam;
a mounting to pivotably mount the emitter; and
a controller coupled to at least the moving part, the emitter and the mounting,
the controller being configured to control the emitter to emit a laser beam of sufficient power to clean the surface and to control the mounting to pivot the emitter in correspondence with movements of the surface to thereby direct the laser beam toward the surface while the surface moves.

10. The laser-based cleaning system according to claim 9, wherein the moving part is at least one of a rotating part and a linearly moving part.

11. The laser-based cleaning system according to claim 9, wherein the emitter comprises:
an emitter portion to emit the laser beam; and
a sensor portion to sense a cleanliness state of the surface, to generate data reflective of the cleanliness state and to forward the data to the controller,
wherein the controller is further configured to control the emitter and the mounting in accordance with at least the data.

12. The laser-based cleaning system according to claim 9, wherein the mounting is movable relative to the moving part and the controller is further configured to control movements of the mounting.

13. The laser-based cleaning system according to claim 9, wherein:
the controller is receptive of information relating to the moving part and controls the emitter and the mounting in accordance with at least the information, and
the information comprises at least one or more of a cleanliness condition of the surface, dimensions of the surface, a position of the surface, a direction of movement of the surface and a speed of movement of the surface.

14. The laser-based cleaning system according to claim 9, wherein the controller generates an artificial intelligence (AI) model to model a cleanliness condition of the surface and controls the emitter and the mounting in accordance with at least the model.

15. The laser-based cleaning system according to claim 9, wherein:
the moving part is one of multiple moving parts, each having a surface to be cleaned, and
the controller controls the emitter and the mounting to clean same portions of each surface of the multiple moving parts before cleaning next portions of each surface of the multiple moving parts.

16. The laser-based cleaning system according to claim 9, wherein:
the moving part is one of multiple moving parts, each having a surface to be cleaned, and
the controller controls the emitter and the mounting to clean each portion of each surface of each of the multiple moving parts before cleaning a portion of a surface of a next one of the multiple moving parts.

17. A method of laser-based cleaning of a surface of a moving part, the method comprising:
pivotably mounting an emitter configured to emit a laser beam on a mounting;
determining a cleanliness condition, dimensions, a position, a direction of movement and a speed of movement of the surface; and
controlling the emitter and the mounting to execute laser-based cleaning of the surface in accordance with results of the determining, the controlling comprising:
positioning the mounting to provide the emitter with a line-of-sight to the surface;
controlling the emitter to emit the laser beam at a sufficient power to clean the surface; and
controlling the mounting to pivot the emitter during movement of the moving part such that the laser beam remains directed toward the surface.

18. The method according to claim 17, wherein the controlling further comprises sensing a cleanliness state of the surface, generating data reflective of the cleanliness state and controlling the emitter and the mounting in accordance with at least the data.

19. The method according to claim 17, wherein the controlling comprises generating an artificial intelligence (AI) model to model a cleanliness condition of the surface and controlling the emitter and the mounting in accordance with at least the model.

20. The method according to claim 17, wherein:
the moving part is one of multiple moving parts, each having a surface to be cleaned, and
the controlling comprises at least one of:
controlling the emitter and the mounting to clean same portions of each surface of the multiple moving parts before cleaning next portions of each surface of the moving rotating parts; and
controlling the emitter and the mounting to clean each portion of each surface of each of the multiple moving parts before cleaning a portion of a surface of a next one of the multiple moving parts.
